(19) United States
(12) Patent Application Publication
(10) Pub. No.: US 2013/0080215 A1
(43) Pub. Date: Mar. 28, 2013

(54) INTELLECTUAL PRODUCTIVITY MEASUREMENT DEVICE, INTELLECTUAL PRODUCTIVITY MEASUREMENT METHOD, AND RECORDING MEDIUM

(71) Applicant: Hideki Kawai, Tokyo (JP)

(72) Inventor: Hideki Kawai, Tokyo (JP)

(73) Assignee: NEC CORPORATION, Minato-ku, Tokyo (JP)

(21) Appl. No.: 13/702,098

(22) PCT Filed: Jun. 6, 2011
(86) PCT No.: PCT/JP2011/062964

§ 371 Date: Dec. 5, 2012

(30) Foreign Application Priority Data
Jun. 18, 2010 (JP) 2010-139713

(51) Int. Cl. G06Q 10/06

(52) U.S. Cl. CPC G06Q 10/06395
USPC 705/7.41

(57) ABSTRACT

Activity information obtainer (10a) of intellectual productivity measurement device (100) obtains activity information representing an activity. Event information obtainer (10b) obtains information representing an event and including a time at which the event occurs. Evaluation obtainer (4) obtains a subjective evaluation. Short-term-context input section (11a) generates a short-term context from the activity information. Long-term-context input section (11b) extracts a long-term context from event information. Model generator (5) generates, using a mapping function from a direct sum space of the space of the short-term context and the space of the long-term context to the space of the subjective evaluation, an estimation model that is a parameter of the mapping function in such a way that values reflecting the short-term context and the long-term context enter within the range of the subjective evaluation. Intellectual productivity calculator (6) calculates an intellectual productivity using the estimation model.

### TECHNICAL FIELD

The present invention relates to an intellectual productivity measurement device, an intellectual productivity measurement method, and a recording medium.

### BACKGROUND ART

It is an important task to evaluate the productivity of an organization in a company organization.

Patent Literature 1 discloses a work-efficiency diagnosis method of precisely measuring working hours of a person and of enabling collection of data relating to a work without any manpower. According to this method, when a worker and a work object become close to each other, pieces of identification information of a data transmitter and an antenna attached to both are input, and such identification information is stored in association with a data input occurred time. Next, working hours, a work amount, and a work-efficiency index value are calculated based on the stored data, and the work-efficiency index value is output. When the work efficiency is low, a work-element hour obtained by decomposing the working hours for each work element is evaluated. The work-element hour that can be a considerable matter based on an output evaluation result is selected by a user, and a proposal for an improvement that reduces the work-element hour is set. Next, an expected effect to be predicted and obtained upon execution of the set proposal for improvement is calculated and output.

Patent Literature 2 discloses an information collecting-analyzing device that can analyze an activity base for business improvement in manufacturing industries, etc. This device finely sorts successive works for each activity unit (an hour, a number of works, etc.), and measures a value for each activity unit. Next, this device multiplies the measured value by the cost of a worker (a standard hourly unit rate) and collects the results, thereby calculating an activity cost for each activity unit. Data on the activity costs is a large amount, but this device collects and analyzes such data within a short time efficiently, and outputs information, such as a virtual change, a draft of an effect, and an improvement information output.

Patent Literature 3 discloses a business-activity analyzing system which predicts an improved effect of a work at a certain precision, and which enables improvement preferentially from a work having a higher improved effect predicted value among the individual works in the whole business activity. This system includes a work database that stores, for each work constituting the business activity, at least a work amount, an accomplishment kind, and an accomplishment amount in association with each other. A work belonging to an analysis-target business activity is selected from the work database as an analysis-target work, and a work amount, accomplishment kind, and accomplishment amount of the analysis-target work are obtained. A work having the same accomplishment kind as the accomplishment kind of the analysis-target work is searched from the work database, and a work efficiency is obtained based on the work amount and accomplishment amount of the searched work. A reference efficiency is set based on at least one obtained work efficiency, and a difference between the work amount of the analysis-target work and a work amount of a case in which the analysis-target work is carried out at the reference efficiency is calculated as a work improvement effect.

Patent Literature 4 discloses a server that measures a work quality. The server records the performance of a worker in an office through a sensor network system, while at the same time, gives work quality information at a given time t through a manpower. Hence, the server generates a model that has the performance and the work quality in association with each other, and estimates the work quality from the performance using this model.

### PRIOR ART LITERATURE

### Patent Literature

Patent Literature 1: Unexamined Japanese Patent Application Kokai Publication No. H07-254024
Patent Literature 2: Unexamined Japanese Patent Application Kokai Publication No. 2003-067452
Patent Literature 3: Unexamined Japanese Patent Application Kokai Publication No. 2007-264908
Patent Literature 4: Unexamined Japanese Patent Application Kokai Publication No. 2009-211574

### DISCLOSURE OF THE INVENTION

### Problems to be Solved by the Invention

According to the above-explained related arts, evaluation of the business activity is made from the standpoint of not a quality but a quantity, and is not suitable in some cases for an actual evaluation. Patent Literatures 3 and 4 disclose that evaluation is made from the standpoint of a quantity also in consideration of a quality, but it is difficult to evaluate the all evaluation targets from the standpoint of a quality.

Since the kind of a business activity and the detail of an activity, and an activity period, etc., are not uniform, it is desirable that, when evaluation results made for respective business activities are matched with an evaluation result obtained from an evaluation in consideration of the whole activity, such evaluation results should be identical to each other as much as possible.

The present invention has been made in view of the above-explained circumstances, and it is an object of the present invention to provide an intellectual productivity measurement device, an intellectual productivity measurement method, and a recording medium which are capable of measuring the intellectual productivity of a person involved in an activity in consideration of the quality and quantity of the detail of an activity and an activity span.

### Means for Solving the Problems

To accomplish the above object, a first aspect of the present invention provides an intellectual productivity measurement device that includes: activity information obtaining means that obtains activity information representing an activity of a person involved in the activity; event information obtaining means that obtains event information including information representing an event to which the activity-involved person participates, and information on a time at which the event occurs; evaluation obtaining means that obtains, for the activity of the activity-involved person, at least one of a subjective evaluation from the activity-involved person and a subjective evaluation from an evaluating person who evaluates the activity-involved person; short-term context calculating means that generates, from the activity information obtained by the activity information obtaining means, a short-term context which is a vector including values of the activity information of a predetermined kind during a predetermined time period arranged as elements of the vector in a predetermined order; long-term context calculating means that extracts a long-term context which is a vector including values of the event information of a predetermined kind during a predetermined time period arranged as elements of the vector in a predetermined order; model generating means that generates, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and intellectual productivity estimating means that calculates, using the estimation model generated by the model generating means, an intellectual productivity that is a mapping to the space of the subjective evaluation from the short-term context of the activity of the activity-involved person and the long-term context thereof.

To accomplish the above object, a second aspect of the present invention provides an intellectual productivity measurement method executed by an intellectual productivity measurement device that estimates an intellectual productivity of an activity of a person involved in the activity, and the method includes: an activity information obtaining step for obtaining activity information representing an activity of a person involved in the activity; an event information obtaining step for obtaining event information including information representing an event to which the activity-involved person participates, and information on a time at which the event occurs; an evaluation obtaining step for obtaining, for the activity of the activity-involved person, at least one of a subjective evaluation from the activity-involved person and a subjective evaluation from an evaluating person who evaluates the activity-involved person; a short-term context calculating step for generating, from the activity information obtained through the activity information obtaining step, a short-term context which is a vector including values of the activity information of a predetermined kind during a predetermined time period arranged as elements of the vector in a predetermined order; a long-term context calculating step for extracting a long-term context which is a vector including values of the event information of a predetermined kind during a predetermined time period arranged as elements of the vector in a predetermined order; a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and an intellectual productivity estimating step for calculating, using the estimation model generated through the model generating step, an intellectual productivity that is a mapping to the space of the subjective evaluation from the short-term context of the activity of the activity-involved person and the long-term context thereof.

To accomplish the above object, a third aspect of the present invention provides a computer-readable recording medium having stored therein an intellectual productivity measuring program that allows a computer to execute: an activity information obtaining step for obtaining activity information representing an activity of a person involved in the activity; an event information obtaining step for obtaining event information including information representing an event to which the activity-involved person participates, and information on a time at which the event occurs; an evaluation obtaining step for obtaining, for the activity of the activity-involved person, at least one of a subjective evaluation from the activity-involved person and a subjective evaluation from an evaluating person who evaluates the activity-involved person; a short-term context calculating step for generating, from the activity information obtained through the activity information obtaining step, a short-term context which is a vector including values of the activity information of a predetermined kind during a predetermined time period arranged as elements of the vector in a predetermined order; a long-term context calculating step for extracting a long-term context which is a vector including values of the event information of a predetermined kind during a predetermined time period arranged as elements of the vector in a predetermined order; a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and an intellectual productivity estimating step for calculating, using the estimation model generated through the model generating step, an intellectual productivity that is a mapping to the space of the subjective evaluation from the short-term context of the activity of the activity-involved person and the long-term context thereof.

### Effects of the Invention

According to the present invention, it becomes possible to measure the intellectual productivity of a person involved in an activity in consideration of the quality and quantity of the detail of an activity, and an activity span.

### BRIEF DESCRIPTION OF DRAWINGS

FIG. 1 is a block diagram illustrating an example configuration of an intellectual productivity measurement device according to a first embodiment;

FIG. 2 is a diagram illustrating example data on a short-term context relating to activity information;

FIG. 3 is a diagram illustrating example data on a long-term context relating to event information;

FIG. 4 is a configuration diagram illustrating an example activity information obtainer (a sensor);

FIG. 5 is a flowchart illustrating an example model constructing process operation by the intellectual productivity measurement device according to the first embodiment;

FIG. 6 is a flowchart illustrating an example intellectual productivity measuring process operation by the intellectual productivity measurement device according to the first embodiment;

FIG. 7 is a flowchart illustrating an example process operation by the intellectual productivity measurement device according to the first embodiment;

FIG. 8 is a block diagram illustrating an example configuration of an intellectual productivity measurement device according to a second embodiment;

FIG. 9 is a flowchart illustrating an example model constructing process operation by the intellectual productivity measurement device according to the second embodiment;

FIG. 10 is a flowchart illustrating an example intellectual productivity measuring process operation by the intellectual productivity measurement device according to the second embodiment; and

FIG. 11 is a block diagram illustrating an example hardware configuration of an intellectual productivity measurement device according to the present invention.

### MODE FOR CARRYING OUT THE INVENTION

Embodiments to carry out the present invention will now be explained in detail below with reference to the accompanying drawings. The same or corresponding structural element will be denoted by the same reference numeral throughout the figures.

Terms that are a short-term context, a long-term context, and an intellectual productivity estimation model will be defined one by one, and used in the following explanation. A short-term context is vectors arranged in a predetermined order with a value of activity information of a predetermined kind during a predetermined time period being as an element. More specifically, the short-term context can be expressed as a change in activity information during a time period Δt before and after a time T. For example, a change in activity information, such as “an amount of communications increases one hour before 12 O'clock with reference to 12 O'clock”, or “an amount of key typing is decreased two hours after 12 O'clock”, is a short-term context, and can be expressed by a physical action by a person involved in an activity.

A long-term context is vectors arranged in a predetermined order with a value of the event information of a predetermined kind during a predetermined time period being as an element. More specifically, the long-term context can be expressed as a change in event information during a time period Δtb before and after a time Tb. The short-term context is a change in information during the before and after time period Δt, while the long-term context indicates a change in information during a time period longer than at least the time period Δt, e.g., a time period on a daily basis or a weekly basis. For example, a change in the event information including a large flow like a work schedule or a work phase, such as “a large amount of programming was made during the last one week”, “a late-night overtime work was done successively in one week”, or “a deadline for a report is coming three days after” is a long-term context, and can affect the fatigue and concentration of a person involved in an activity.

When the intellectual productivity of a person involved in an activity is estimated in consideration of the long-term context, it is unpractical to express the long-term context as a change in activity information like the short-term context. In order to obtain the short-term context, changes in all pieces of sensor data contained in a window size during the time period Δt before and after the given time T are necessary. Conversely, in order to obtain the long-term context, changes in all pieces of sensor data contained in a window size during Δd days before and after the given time Tb, i.e., an arbitrary day D are necessary. Hence, the obtained long-term context has a massive data amount, and includes large noises that do not affect the intellectual productivity. For example, when 10 kinds of sensors that obtain data at a cycle of a sampling per a second are used, pieces of data of one week before and after the time t are 3600×24×7×2×10=12096000 pieces of data. Moreover, the short-term context expresses a most recent performance of a job or a work using sensor data, while the long-term context expresses a phase of the job or the work. Hence, it is necessary to obtain the long-term context from a scheduler or a process managing tool rather than the sensor data.

According to the present invention, the long-term context is expressed using event information of a person involved in such an event. An event in which the person is involved is an event at least partially constituted by an object of an activity or a result thereof. Example events are a meeting, an overtime work, a created document, and a deadline of an accomplishment. Information (letter strings or symbols) expressing an event and information on time when such an event occurs are collectively referred to as event information. Information on a time when an event occurs includes a number of occurrences of the event during a predetermined time period, the frequency or the occurrence cycle, or the percentage of the time when the event is occurring relative to the predetermined time period. The event information may express an event corresponding to a position in the long-term context.

An intellectual productivity estimation model is a model setting parameters of a mapping function in such a way that, using a predetermined mapping function from a direct sum space of a space of the short-term context and a space of the long-term context to a space of a subjective evaluation, values reflecting the short-term context of a person involved in an activity and the long-term context thereof enter within a predetermined range of the subjective evaluation to that person.

### First Embodiment

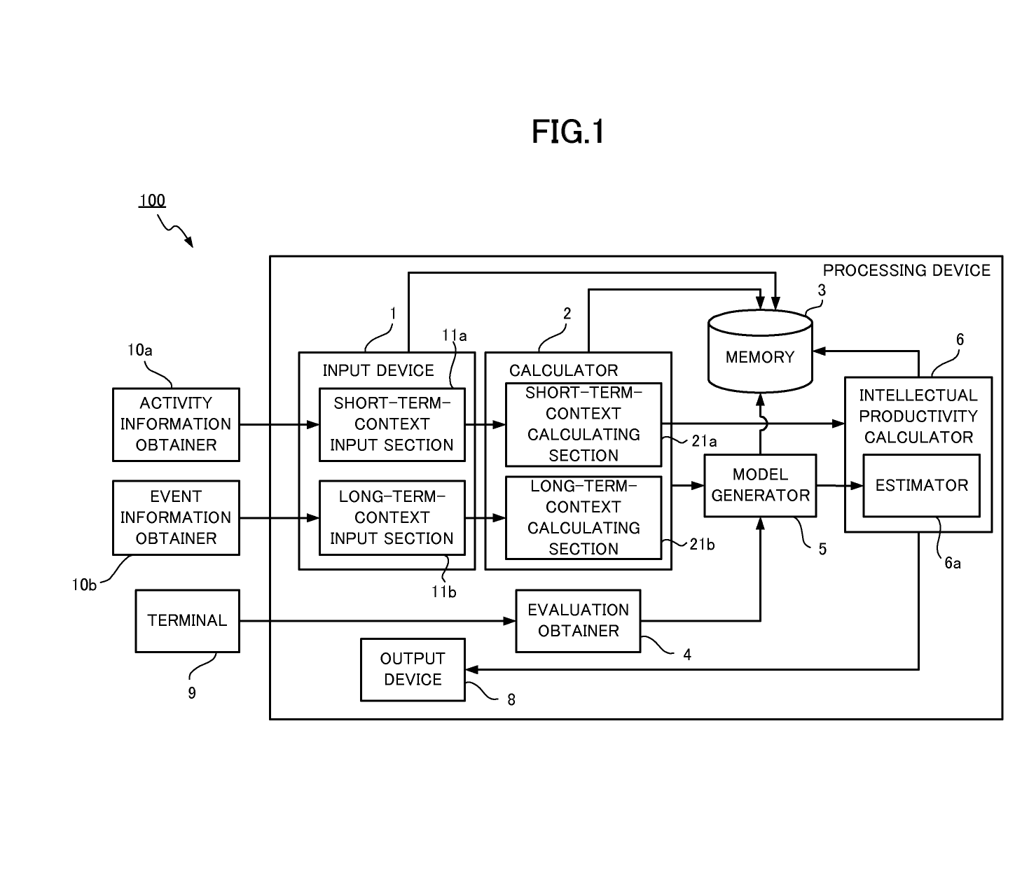

FIG. 1 is a block diagram illustrating an example configuration of an intellectual productivity measurement device according to a first embodiment of the present invention. An intellectual productivity measurement device 100 includes a processing device, a terminal 9, an activity information obtainer 10a and an event information obtainer 10b. The processing device operates under the control of a program. The processing device includes an input device 1, a calculator 2, a memory 3, an evaluation obtainer 4, a model generator 5, an intellectual productivity calculator 6 and an output device 8.

The input device 1 includes a short-term-context input section 11a and a long-term-context input section 11b. The calculator 2 includes a short-term-context calculating section 21a and a long-term-context calculating section 21b. The memory 3 stores, for example, obtained information and results of calculation processes and those of estimation processes. It is optional that the memory 3 may not be configured as a part of the processing device, but may be configured over a memory device, such as a hard disk or a flash memory. The intellectual productivity calculator 6 includes an estimator 6a.

The activity information obtainer 10a monitors an activity of a person involved in that activity through sensors and inputs data that is activity information to the short-term-context input section 11a.

The activity information obtained by the activity information obtainer 10a is stored in the memory 3 through the short-term-context input section 11a, and is stored together with a time stamp TS. Example sensor data representing activity information are positional information of the person involved in the activity, visual line information, environmental sound information around the activity, uttered sound information, operation information given to a computer input device, operation information given to a software, and operation information given to an office equipment. More specifically, the operation information given to the computer input device includes a typing amount, a displacement of a mouse, and the number of right and left clicks of the mouse, etc. The operation information given to the software includes an operation log over a computer, a file name created, edited, and browsed, and the name of receiver/transmitter of a mail, etc.

The event information obtainer 10b inputs, to the long-term-context input section 11b, the event information including information representing an event to which the person involved in the activity participates, and information on a time when such an event occurs in the form of, for example, text data.

The event information obtained by the event information obtainer 10b is stored in the memory 3 through the long-term-context input section 11b. The event information is information including the number of the occurrences of an event of an arbitrary kind, the frequency or the occurrence cycle, or the percentage of the time when the event is occurring during a predetermined time period. The event information is long-term schedule data representing the phase of a job or a work of the person involved in the activity, such as a schedule table, a timetable, an activity achievement table, a process managing table, or an activity report. In more detail, such data includes a plan registered on a scheduler, the number of registered To-Do items, the number of done To-Do items, and the progress level of a process managing table like a Gantt Chart, etc.

The calculator 2 includes the short-term-context calculating section 21a and the long-term-context calculating section 21b.

The short-term-context calculating section 21a calculates a short-term context during the before and after Δt time period at a cycle of a short-term-context sampling period τ_t among the activity information stored in the short-term-context input section 11a or stored in the memory 3 through the short-term-context input section 11a. Moreover, the short-term-context calculating section 21a stores a calculated result in the memory 3.

The long-term-context calculating section 21b calculates a long-term context during the before and after Δd days at a cycle of a long-term-context sampling period τ_d among the event information stored in the long-term-context input section 11b or stored in the memory 3 through the long-term-context input section 11b. Moreover, the long-term-context calculating section 21b stores a calculated result in the memory 3.

The memory 3 stores a value or a change in sensor data which is the activity information obtained by the short-term-context input section 11a and is the short-term context during the before and after Δt time period for an arbitrary time T. Δt is, for example, 30 minutes or 1 hour.

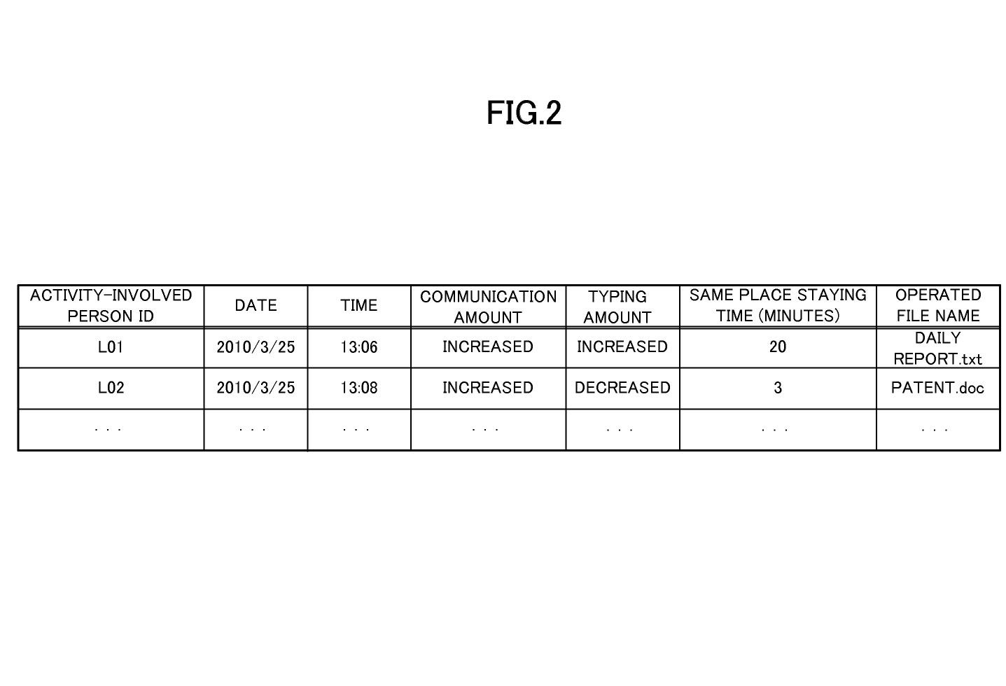

FIG. 2 is a diagram illustrating example short-term context data relating to activity information. It is clear from this figure that a communication amount during the Δt time period before and after 13:06, Mar. 25, 2010 for an activity-involved person ID that is L01 tended to increase, a typing amount tended to increase, a staying time period at the same place was 20 minutes, and the name of operated file was “daily report.txt”. Moreover, a communication amount during the Δt time period before and after 13:08, Mar. 25, 2010 for an activity-involved person ID that is L02 tended to increase, a typing amount tended to decrease, a staying time period at the same place was 3 minutes, and the name of operated file was “patent.doc”. It becomes clear from those pieces of information that, for example, even though the activity-involved person L02 was doing a job relating to a patent, a typing amount while staying at the same place decreased but a time for a communication increased. As is indicated by this example, the kinds of the short-term context include (A) a value, (B) a tendency of increase/decrease, and (C) letter strings, etc. When (A) the value is directly used as vector data, the increase or the decrease is converted into numerical expression like +1 or −1 for (B) the tendency of increase/decrease, and the condition whether or not the same elements as the letter strings are included is expressed by 1 or 0 for (C) the letter strings, the short-term context can be expressed as a vector. For example, in the example case illustrated in FIG. 2, respective short-term contexts of the activity-involved persons L01 and L02 can be expressed by five-dimensional vectors of {communication amount, typing amount, same place staying time (minutes), daily report.txt, and patent.doc}, and can be expressed as follows.

{+1, +1, 20, 1, 0} and

{+1, —1, 3, 0, 1}

The memory 3 also stores, as the long-term context, the event information obtained by the long-term-context input section 11b and including particular events extracted among the events occurred during the before and after Δd days including an arbitrary time t (indicating an arbitrary date D).

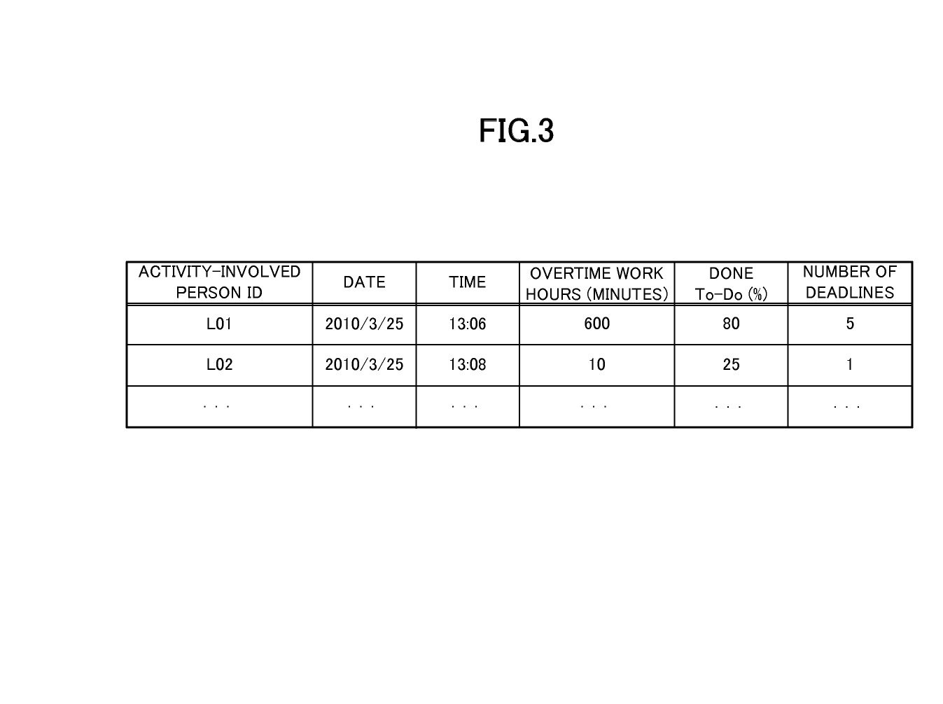

FIG. 3 is a diagram illustrating example long-term context data relating to event information. It becomes clear from this figure that overtime work hours during Δd days before and after 13:06, Mar. 25, 2010 for the activity-involved person ID of L01 were 600 minutes, a done To-Do was 80%, and the number of deadlines was five. Moreover, it becomes clear that overtime work hours during Δd days before and after 13:08, Mar. 25, 2010 for the activity-involved person ID of L02 were 10 minutes, a done To-Do was 25%, and the number of deadlines was one. The long-term context data can be also described in the vector expression like the short-term context data. In the example case illustrated in FIG. 3, for example, respective long-term contexts of the activity-involved persons L01 and L02 can be expressed by three-dimensional vectors of {overtime work hours, done To-Do, and number of deadlines}, and can be expressed as follows.

{600, 80, 5} and

{10, 25, 1}

The evaluation obtainer 4 prompts the activity-involved person, a supervisor, or a coworker, etc., to input a subjective evaluation at a random time during a day for an activity that is desired to calculate an intellectual productivity, and obtains such an evaluation through the terminal 9. The evaluation obtainer 4 stores the obtained subjective evaluation in the memory 3. At this time, an example method of prompting an input is to transmit a mail and to describe the URL of a Web question page in that mail. In addition, a method of, for example, popping up a new window in a computer and of displaying questions on that window is possible, and the present invention is not limited to the method explained in this embodiment. Moreover, a predetermined day or time, such as Monday in every week or the afternoon in Thursday, may be set instead of prompting an inputting of the subjective evaluation at a random time in a day. It is unnecessary that the frequency of prompting an input be limited to a day.

The model generator 5 generates an estimation model for estimating the subjective evaluation stored in the memory 3 using the short-term context data relating to the activity information stored in the memory 3 and the long-term context data relating to the event information. For example, the model generator 5 obtains a multiple regression equation that explains the intellectual productivity through a multiple regression analysis with the short-term context and the long-term context being as feature vectors. More specifically, generation of the estimation model is carried out by setting parameters of a mapping function in such a way that values reflecting the short-term context and the long-term context enter within the predetermined range of the subjective evaluation using the predetermined mapping function from a direct sum space of the space of the short-term context and the space of the long-term context to the space of the subjective evaluation.

The intellectual productivity calculator 6 measures the intellectual productivity with reference to the data in the memory 3. For an activity having no subjective evaluation, the intellectual productivity calculator 6 performs measurement through an estimation by the estimator 6a of the intellectual productivity calculator 6. More specifically, the intellectual productivity calculator 6 refers to the data in the memory 3, and measures the intellectual productivity directly through a predetermined method for the activity having the short-term context, the long-term context, and the subjective evaluation stored in the memory. Moreover, the intellectual productivity calculator 6 refers to the data in the memory 3, and instructs the estimator 6a to estimate the intellectual productivity for the activity having the short-term context and the long-term context stored in the memory but the subjective evaluation not stored therein. The estimator 6a refers to the estimation model for the intellectual productivity generated by the model generator 5 and stored in the memory 3, and estimates the intellectual productivity using the estimation model. The intellectual productivity calculator 6 may store the measured intellectual productivity of the activity in the memory 3.

The output device 8 outputs the intellectual productivity of the activity measured by the intellectual productivity calculator 6 together with the activity. The output device 8 may be configured as a part of the terminal 9 that is used when the subjective evaluation is input into the evaluation obtainer 4.

The memory 3 also stores the subjective evaluation input through the terminal 9 and obtained by the evaluation obtainer 4. More specifically, the memory 3 stores an evaluation result of the intellectual productivity input manually at a random time. The simplest data structure of the evaluation result can be expressed as {activity-involved person ID, date and hour, time, and intellectual productivity score}. For example, the intellectual productivity score indicates the subjective evaluation that is a result of evaluating the level of the intellectual productivity by the activity-involved person himself/herself converted in a numerical expression in multiple stages. In order to simplify the explanation, the simplest data structure is explained, but it is unnecessary that the intellectual productivity score is a single index, and individual subjective evaluations to elements relating to the intellectual productivity, such as “worthwhile”, “can express the personality”, “enjoying”, “devoting”, “seeking various ideas”, and “cooperating”, may be used and a total or an average value of respective elements of the subjective evaluation may be used, and the present invention is not limited to the method explained in this embodiment. Moreover, in addition to the subjective evaluation relating to the intellectual productivity from the individual activity-involved person himself/herself, a total or an average value of the subjective evaluations from a supervisor or a coworker to an activity-involved person may be used, and the present invention is not limited to the method explained in this embodiment.

The memory 3 further stores the model (the estimation model) constructed and generated by the model generator 5 for estimating the intellectual productivity. The model generator 5 constructs the estimation model through procedures to be explained later using the contexts input through the short-term context input section 11a and the long-term context input section 11b. An example estimation model can be expressed as follow using an explanatory variable Z of the intellectual productivity, short-term contexts x_{—}1 to x_m, weights a_{—}1 to a_m of the short-term contexts, long-term contexts y_{—}1 to y_n, weights b_{—}1 to b_n of the long-term contexts, and an intercept c.

Z=(a_{—}1×x_{—}1+a_{—}2×x_{—}2+ . . . +a_{—}m×x_{—}m)+(b_{—}1×y_{—}1+b_{—}2×y_{—}2+ . . . +b_{—}n×y_{—}n)+c

Although the explanation was given of the example case in which the multiple regression equation is used as an example estimation model of the intellectual productivity, a hyperplane equation which expresses the high/low of the intellectual productivity by two values and which divides a multi-dimensional feature space including the short-term context and the long-term context into two spaces may be used, and the present invention is not limited to the method explained in this embodiment.

The memory 3 stores a value of the intellectual productivity measured by the intellectual productivity calculator 6. The value of the intellectual productivity may be not only to the activity with the subjective evaluation but also to the activity having no subjective evaluation. The value of the intellectual productivity to the activity having no subjective evaluation includes a value obtained by estimating the subjective evaluation through the estimator 6a that refers to the estimation model.

The value of the intellectual productivity is a value obtained based on the estimation model for the intellectual productivity generated by the model generator 5 with respect to the activity having the short-term context and the long-term context but no subjective evaluation for a given time t. The basis data structure of the intellectual productivity is {activity-involved person ID, date, time, intellectual productivity estimated value}.

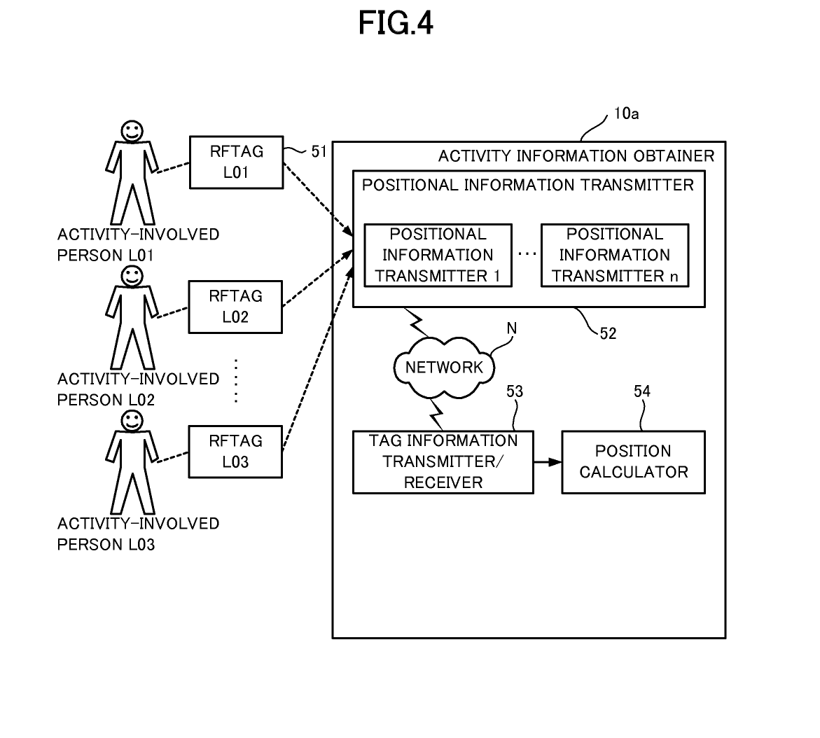

FIG. 4 is a configuration diagram illustrating an example activity information obtainer (a sensor). A sensor that is example means for obtaining the activity information is an RF (Radio Frequency) tag, and obtains the activity information relating to a position. The activity information obtainer 10a includes an RF tag 51, a positional information transmitter 52, a tag information transmitter/receiver 53, and a position calculator 54.

The positional information transmitter 52 receives radio waves from the RF tag 51 (corresponding to RF tag L01, RF tag L02 or RF tag L03 in the figure) possessed by the activity-involved person (corresponding to activity-involved person L01, activity-involved person L02 or activity involved-person L03 in the figure). The tag information transmitter/receiver 53 receives tag information of the positional information transmitter 52 via a network N, and transmits the identification information of the corresponding activity-involved person and the positional information thereof to the position calculator 54. The position calculator 54 calculates the position of the activity-involved person. The activity information obtainer 10a obtains information on the positional information of the activity-involved person.

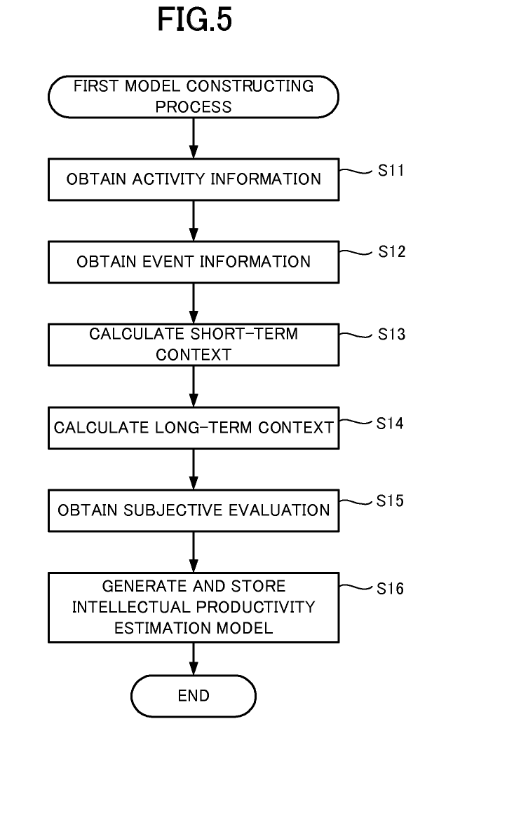

FIG. 5 is a flowchart illustrating an example model constructing process operation by the intellectual productivity measurement device according to the first embodiment.

First, the activity information obtainer 10a obtains the activity information of the activity-involved person (step S11). The activity information is obtained through, for example, obtaining sensor data. Moreover, the event information obtainer 10b obtains the event information including information representing the event to which the activity-involved person participates, and information on a time at which the event occurs (step S12).

Next, the short-term-context calculating section 21a calculates the short-term context based on the activity information input through the short-term-context input section 11a (step S13). Likewise, for the long-term context, the long-term-context calculating section 21b calculates the long-term context based on the event information input through the long-term-context input section 11b (step S14).

Subsequently, the evaluation obtainer 4 obtains the subjective evaluation to the activity (step S15). The subjective evaluation used is one that is input through the terminal 9 by at least either one of the activity-involved person and an evaluating person. The model generator 5 derives a relationship between the short-term context, the long-term context and the subjective evaluation for the corresponding activity using the short-term context calculated in the step S13, the long-term context calculated in the step S14, and the subjective evaluation obtained in the step S15, generates the estimation model for the intellectual productivity, and stores the generated estimation model (step S16). Thereafter, successive operations are terminated. Information subjected to an input, a calculation, and an obtainment, etc., in respective steps S13 to S16 may be stored and retained in the memory 3 every time such information is subjected to such an operation.

More specifically, the following operations are performed in respective steps.

The short-term-context calculating section 21a calculates in the step S13 the short-term context of the before and after Δt time period at a cycle of the context sampling period τ_t among the pieces of sensor data on the activity information in the short-term-context input section 11a.

The long-term-context calculating section 21b calculates in the step S14 the long-term context of the before and after Δd days at a cycle of the context sampling period τ_d among the pieces of data on the event information in the long-term-context input section 11b.

The evaluation obtainer 4 may transmit a mail to the terminal 9 or cause the terminal 9 to display a screen which prompts inputting of the subjective evaluation for the intellectual productivity of the activity-involved person at a random time in a day in the step S15. Moreover, the person giving the subjective evaluation is not limited to the activity-involved person but may be an evaluator, such as the supervisor of the activity-involved person or the coworker thereof, and an inputting of the evaluation to the activity may be prompted to the person giving the subjective evaluation. The frequencies of the mail transmission and the screen display which are the method of prompting the inputting can be set arbitrary.

The model generator 5 obtains in the step S16 the multiple regression equation that explains the intellectual productivity through the multiple regression analysis with the short-term context calculated in the step S13 and the long-term context calculated in the step S14 being as feature vectors. The obtained estimation model is stored and retained in the memory 3 every time such a model is generated. The multiple regression equation is an example estimation model for the intellectual productivity, and the estimation model constructed and generated by the model generator 5 is not always limited to such an example.

In order to facilitate understanding, the explanation was given of the method that successively executes the processes from the step S11 to the step S16 in this embodiment, but it is fine if respective steps are repeatedly executed at individual cycles, and the present invention is not limited to the method explained in this embodiment. As the example execution cycles of the respective steps, the following combination is possible.

Activity information sensor obtaining process (step S11): every one second.

Event information data obtaining process (step S12): every 12 hours.

Short-term context process (step S13): every two hours.

Long-term context process (step S14): every one day.

Subjective evaluation obtaining process (step S15): three to five times or so in a day at a random cycle.

Intellectual productivity estimation model generating/storing process (step S16): executed together with the subjective evaluation obtaining process (step S15).

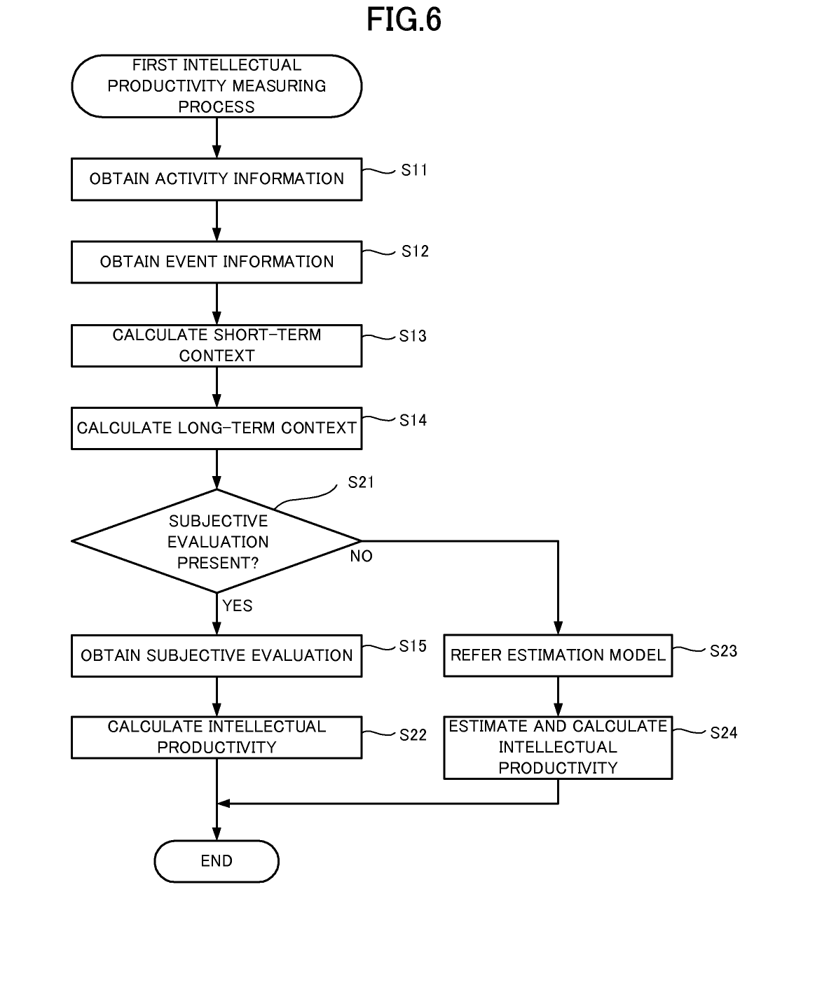

FIG. 6 is a flowchart illustrating an operation of an example first intellectual productivity measuring process by the intellectual productivity measurement device according to the first embodiment.

The operations from the step S11 to the step 14 are the same as those from the step S11 to the step S14 of the model constructing process operation in FIG. 5.

After the completion of the calculation of the short-term context (step S13) and the calculation of the long-term context (step S14), the evaluation obtainer 4 obtains the subjective evaluation (step S15) when there is the obtained subjective evaluation (step S21: YES). Next, the intellectual productivity calculator 6 measures, i.e., calculates the intellectual productivity (step S22), and terminates the successive processes. With respect to the measurement of the intellectual productivity, the subjective evaluation is associated with a given activity with the short-term context and the long-term context being as feature vectors to measure the intellectual productivity. The subjective evaluation obtaining operation in the step S15 is the same as that of the model constructing process operation in the step S15 and in FIG. 5.

The evaluation obtainer 4 refers to the estimation model for the intellectual productivity constructed and generated by the model generator 5 when there is no obtained subjective evaluation (step S21: NO) (step S23). The estimator 6a estimates the subjective evaluation to the target activity with reference to the referred estimation model. That is, the intellectual productivity calculator 6 estimates and measures, i.e., calculates the intellectual productivity with the short-term context and the long-term context being as feature vectors (step S24), and terminates the successive processes. In more detail, the estimator 6a of the intellectual productivity calculator 6 estimates the subjective activity evaluation for the activity having no evaluation obtained through the evaluation obtainer 4 using the estimation model generated by the model generator 5, and uses the estimated evaluation for measurement of the intellectual productivity.

The results of the calculation of the intellectual productivity by the intellectual productivity calculator 6 in the step S22, and the estimation and calculation of the intellectual productivity by the intellectual productivity calculator 6 in the step S24 may be stored and retained in the memory 3. Regarding the execution cycles of the processes by the intellectual productivity calculator 6, for example, respective processes are set as follows.

Intellectual productivity calculating process (step S22) and intellectual productivity estimating and calculating process (step S24): every two hours.

Respective processes may be executed without following the above-explained order, and may be repeatedly executed at individual cycles.

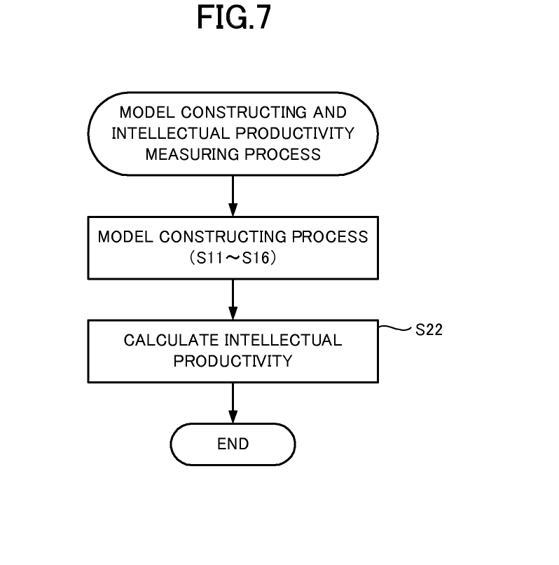

When there is the subjective evaluation to be obtained (step S21: YES), the model constructing process and the intellectual productivity measuring process are collectively executable, and, like the flowchart of FIG. 7 illustrating an example process operation by the intellectual productivity measurement device according to the first embodiment, can be simplified. It is desirable that the estimation model generated and stored and the intellectual productivity measured eventually should be stored and retained in the memory 3.

### Second Embodiment

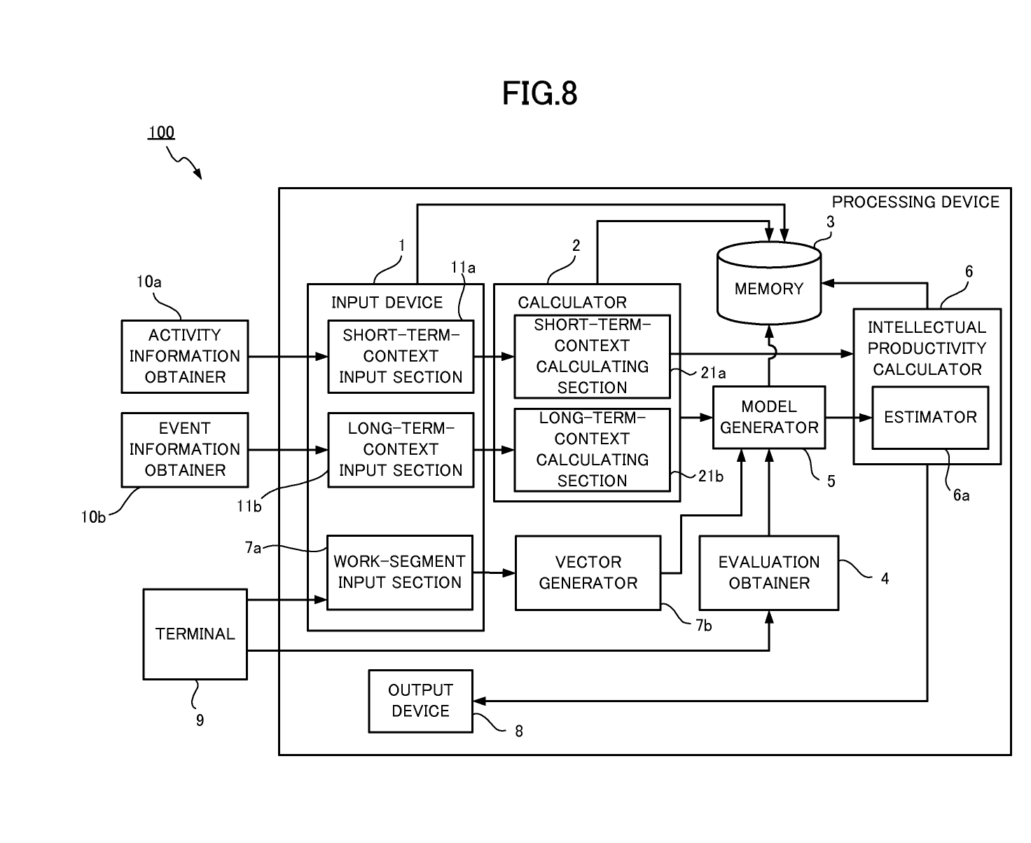

FIG. 8 is a block diagram illustrating an example configuration of an intellectual productivity measurement device according to a second embodiment of the present invention. An intellectual productivity measurement device 100 of the second embodiment includes a structure that allows the activity-involved person himself/herself to directly input the activity information, and such information (referred to as a work segment) is expressed by feature vectors and taken into consideration when the intellectual productivity is measured.

The intellectual productivity measurement device 100 of the second embodiment corresponds to the intellectual productivity measurement device 100 of the first embodiment which includes a work-segment input section 7a and a vector generator 7b, and which stores and retains the input information in the memory 3.

The work-segment input section 7a causes the activity-involved person himself/herself to input an annotation to the effect that from what time and until what time the activity-involved person did a work, and what work the activity-involved person did for a given activity, and stores and retains an input result in the memory 3. When performing an input operation to the work-segment input section 7a, the activity-involved person can use the terminal 9, etc. In order to reduce the work burden, the details of the work are indicated by a menu in advance, and the activity-involved person selects a work start time, a work end time, and one of the work menus, thereby inputting the annotation.

The memory 3 stores the work of each activity-involved person and the annotation information on the work hours through the work-segment input section 7a. A specific data structure is {activity-involved person ID, start time, end time, work detail, and association information}. For example, the work that “the activity-involved person L01 wrote a mail to the activity-involved person L02 from 2010/3/25, 10:00 to 10:30” can be expressed in the form of {activity-involved person L01, 2010/3/25 10:00, 2010/3/25 10:30, writing mail, destination: L02}.

The vector generator 7b generates feature vectors arranged in time series in a predetermined time period using the work segment obtained through the work-segment input section 7a.

For example, time-series data of the work of the activity-involved person before and after a given time t can be obtained from the data obtained through the work-segment input section 7a. It is presumed that an activity-involved person did a work A at a time T, was doing works from a work B to a work C 30 minutes before the time T, continued the work A after the time T, did the works from a work D to the work B 30 minutes after the continuation of the work A, and did the work D again. In this case, the time-series data of the works during the 30 minutes before and after the time T is “work B, work C, work A, work D, work B, and work D” in this order. This can be expressed as feature vectors by giving respective unique IDs to the work A to the work D. When, for example, IDs which are 1001 to 1004 are given to the work A to the work D, the feature vector of the feature of the time-series data of the works can be expressed as {1002, 1003, 1001, 1004, 1002, 1004}.

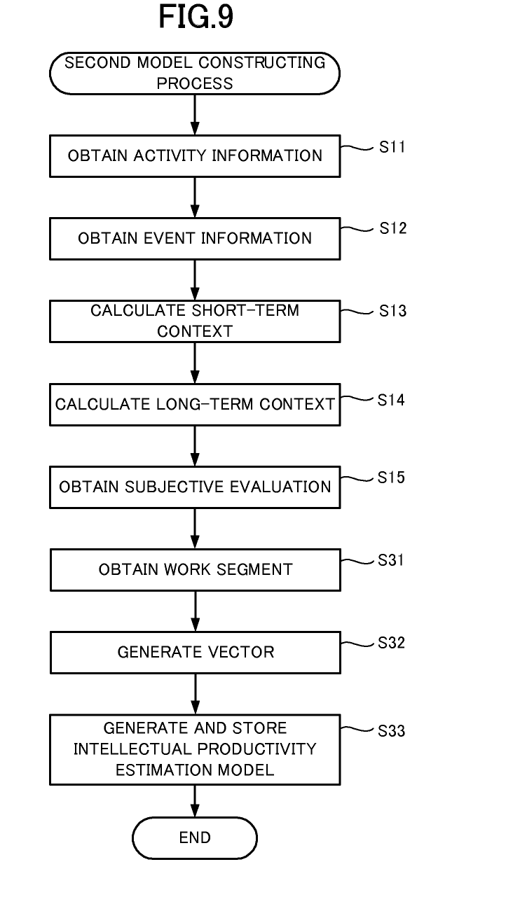

FIG. 9 is a flowchart illustrating an example model constructing process operation by the intellectual productivity measurement device according to the second embodiment. The basic process operation of a second model constructing process is the same as that of a first model constructing process in FIG. 5. In the operation of the second model constructing process, after the subjective evaluation is obtained (step S15), a work segment obtaining operation (step S31) and a vector generating operation (step S32) are executed.

After the subjective evaluation is obtained (step S15), the work-segment input section 7a obtains the work segment information including the work detail of the activity, the work start time and the work end time all input by the activity-involved person (step S31). The vector generator 7b generates, from the work segment information, a feature vector having the elements of the work segment information arranged in time series (step S32).

The model generator 5 derives a relationship between the short-term context, the long-term context, the feature vector and the subjective evaluation for the target activity using the short-term context calculated in the step S13, the long-term context calculated in the step S14, and the feature vector obtained in the step S32, and generates and stores the estimation model for the intellectual productivity (step S33). Thereafter, successive operations are terminated. Information subjected to an input, a measurement, and an obtainment, etc., in each step from the step S13 to the step S15 and from the step S31 to the step S33 may be stored and retained in the memory 3 every time such information is subjected to such operation or may be collectively stored and retained in the memory 3.

More specifically, the following operations are executed for the step S33. The model generator 5 obtains the multiple regression equation that explains the intellectual productivity through the multiple regression analysis using the feature vector generated in the step S32 in addition to the short-term context calculated in the step S13 and the long-term context calculated in the step S14 which are the feature vectors, respectively. Moreover, the obtained estimation model is stored and retained in the memory 3 every time such a model is generated. The multiple regression equation is an example estimation model of the intellectual productivity, and the estimation model constructed and generated by the model generator 5 is not limited to such an example.

Regarding the step S33, the model generator 5 may generate the estimation model for the intellectual productivity that is the parameters of a mapping function in such a way that values reflecting the short-term context of the activity-involved person, the long-term context thereof, and the feature vector enter within the predetermined range of the subjective evaluation to the activity-involved person using the predetermined mapping function from the direct sum space of the space of the short-term context, the space of the long-term context, and the space of the feature vector of the work segment generated in the step S32 to the space of the subjective evaluation.

In the basic process of the second model constructing process, like the first model constructing process, it is fine if respective processes are repeatedly executed at individual cycles and the present invention is not limited to the method explained in this embodiment.

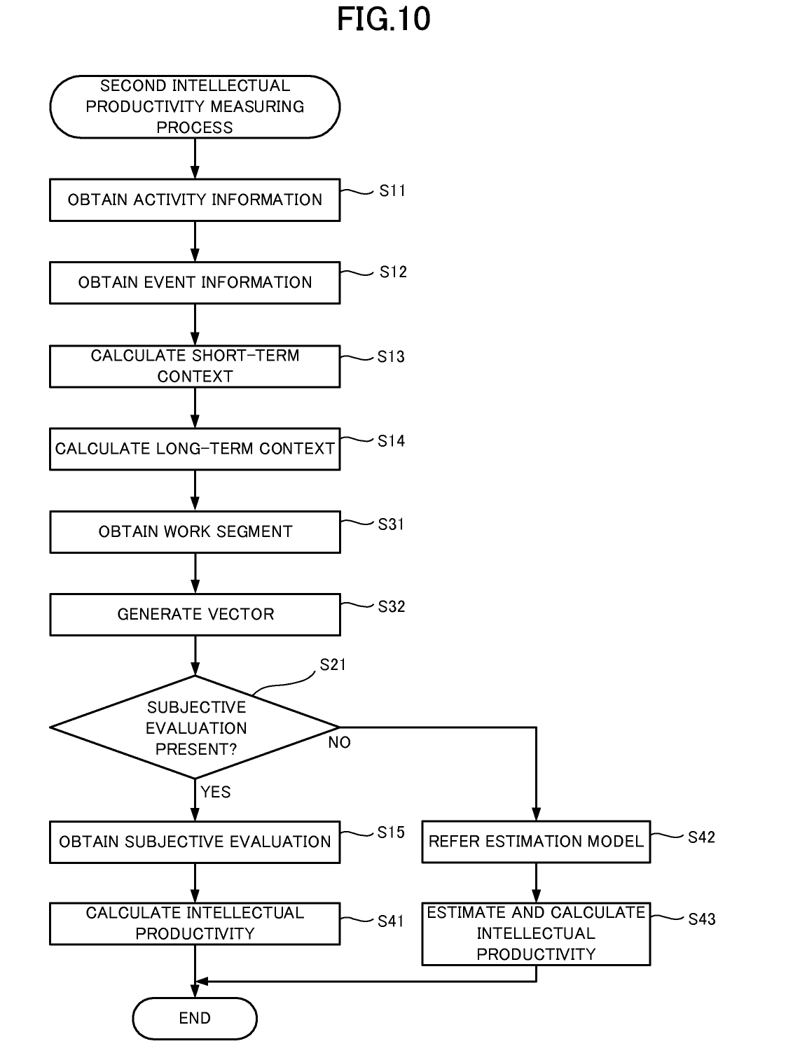

FIG. 10 is a flowchart illustrating an example intellectual productivity measuring process operation by the intellectual productivity measurement device according to the second embodiment. The basic process operation of a second intellectual productivity measuring process is the same as that of the first intellectual productivity measuring process in FIG. 6. In the operation of the second intellectual productivity measuring process, after the calculation of the short-term context (step S13) and the calculation of the long-term context (step S14), an operation of obtaining the work segment (step S31) and an operation of generating a vector (step S32) are executed. Those additional operations are consistent with the basic process operations of the second model constructing process, and thus the explanation thereof will be omitted.

The estimation model for the intellectual productivity used through the operation of the second intellectual productivity measuring process is substantially same as the estimation model for the intellectual productivity used through the operation of the first intellectual productivity measuring process, and is used in consideration of the feature vector in addition to the short-term context, the long-term context, and the subjective evaluation at the time of constructing the estimation model for the intellectual productivity. Hence, the intellectual productivity calculation (step S22), the reference of the estimation model for the intellectual productivity (step S23), and the estimation and calculation of the intellectual productivity (step S24) in the operations of the first intellectual productivity measuring process are substantially same as the intellectual productivity calculation (step S41), the reference of the estimation model for the intellectual productivity (step S42), and the estimation and calculation of the intellectual productivity (step S43) in the operations of the second intellectual productivity measuring process.

In the measurement of the intellectual productivity, i.e., the calculation or the estimation and calculation, unlike the first embodiment, the model generator 5 constructs the estimation model for the intellectual productivity using not only the short-term context and the long-term context but also the feature vector of the time-series data of the work input through the work-segment input section 7a and generated by the vector generator 7b. Eventually, the intellectual productivity calculator 6 measures the intellectual productivity.

According to the intellectual productivity measurement device of the first embodiment, the intellectual productivity of the activity-involved person is measurable in consideration of the quality and quantity of the detail of the activity, and the activity span. This is because the short term context is extracted which is the value or the change in the sensor data on the basis of the before and after several minutes or several hours at a preset cycle among the pieces of sensor data, the long-term context is extracted which is the number of occurrences of the event and the occurrence probability thereof on the basis of the before and after several days, and the estimation model for the intellectual productivity of the activity-involved person is constructed using both pieces of data.

The intellectual productivity measurement device of the first embodiment divides the contexts into the two kinds: the short-term context; and the long-term context in consideration of the activity span mainly, and generates, for the long-term context, the feature vector using the aggregate calculation result focusing on the occurrence of a particular event among the sensor data by what corresponds to several days. Hence, the intellectual productivity of the activity-involved person is measurable in consideration of the short-term and long-term contexts.

The intellectual productivity measurement device of the second embodiment causes the activity-involved person to input the work start time and the end time, and constructs the estimation model for the intellectual productivity utilizing the feature vector that reflects the time-series order of the works. Hence, a change in the intellectual productivity in accordance with the order of the works such that the intellectual productivity increases if a work Y is done in advance to carry out a work X is measurable.

According to the intellectual productivity measurement devices of the embodiments of the present invention, the intellectual productivity is measurable in consideration of the activity span including a future event, in particular, the long-term context. Moreover, in a case in which data is insufficient for the subjective evaluation of the activity-involved person and the annotation, etc., obtained from and input by the activity-involved person, such insufficient data can be estimated, thereby enabling the further precise measurement of the intellectual productivity.

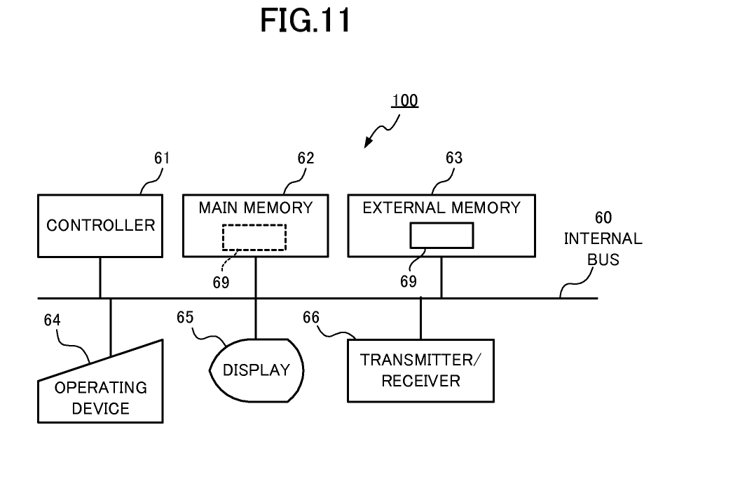

FIG. 11 is a block diagram showing an example physical configuration of the intellectual productivity measurement devices of the embodiments of the present invention illustrated in FIG. 1 and FIG. 8. As illustrated in FIG. 11, the intellectual productivity measurement device 100 includes a controller 61, a main memory 62, an external memory 63, an operating device 64, a display 65, and a transmitter/receiver 66. The main memory 62, the external memory 63, the operating device 64, the display 65, and the transmitter/receiver 66 are all connected to the controller 61 via an internal bus 60.

The controller 61 includes a CPU (Central Processing Unit), etc., and executes the processes related to the intellectual productivity measurement in accordance with a control program 69 stored in the external memory 63.

The main memory 62 includes a RAM (Random-Access Memory), etc., loads therein the control program 69 stored in the external memory 63, and is used as a work area for the controller 61.

The external memory 63 includes a non-volatile memory, such as a flash memory, a hard disk, a DVD-RAM (Digital Versatile Disc Random-Access Memory), or a DVD-RW (Digital Versatile Disc ReWritable). The external memory 63 stores in advance the control program 69 to cause the controller 61 to execute the above-explained processes. Moreover, the external memory 63 supplies data stored by the control program 69 to the controller 61 in accordance with an instruction from the controller 61, and stores data supplied from the controller 61.

The operating device 64 includes a keyboard, a pointing device like a mouse, and an interface device that connects the keyboard and the pointing device, etc., to the internal bus 60.

The display 65 includes a CRT (Cathode Ray Tube) or an LCD (Liquid Crystal Display), etc., and displays, for example, a result of the intellectual productivity measurement.

The transmitter/receiver 66 includes a wireless transmitter/receiver, a wireless modem or a network terminating device, and a serial interface or a LAN (Local Area Network) interface connected to the former device. Information on the intellectual productivity is exchanged through the transmitter/receiver 66.

Respective processes by the input device 1 (including the short-term-context input section 11a and the long-term-context input section 11b), the calculator 2 (including the short-term-context calculating section 21a and the long-term-context calculating section 21b), the memory 3, the evaluation obtainer 4, the model generator 5, the intellectual productivity calculator 6 (including the estimator 6a), the work-segment input section 7a, the vector generator 7b, and the output device 8 of the intellectual productivity measurement devices 100 illustrated in FIG. 1 and FIG. 8 are executed and processed by the control program 69 that uses the controller 61, the main memory 62, the external memory 63, the operating device 64, the display 65 and the transmitter/receiver 66, etc., as resources.

In addition, the above-explained hardware configurations and flowcharts are merely examples, and can be changed and modified in various forms.

The major part including the controller 61, the main memory 62, the external memory 63, the operating device 64, and the internal bus 60, etc., and executing the control process can be implemented by a normal computer system, not by an exclusive system. For example, a computer program for executing the above-explained operations is distributed in a manner stored in a computer-readable recording medium (e.g., a flexible disk, a CD-ROM, or a DVD-ROM), and such a computer program is installed in a computer, thereby configuring the intellectual productivity measurement device 100 that executes the above-explained processes. Moreover, the computer program may be stored in a storage device of a server device over a communication network like the Internet, and may be downloaded to a normal computer system to configure the intellectual productivity measurement device 100.

When, for example, the function of the intellectual productivity measurement device 100 is beard by an OS (Operating System) and an application program or is realized by the cooperative operations of the OS and the application program, only the application program part may be stored in a recording medium or a storage device.

The computer program may be superimposed on carrier waves, and may be distributed over a communication network. For example, the computer program may be posted on a bulletin board (BBS: Bulletin Board System) over a communication network, and such a computer program may be distributed over the network. The computer program is activated, and is executed like the other application program under the control of the OS, thereby making the above-explained process executable.

Some of or all of the above-explained embodiments can be described as the following supplementary notes, but the present invention is not limited to the following supplementary notes.

(Supplementary note 1)

An intellectual productivity measurement device including:

activity information obtaining means that obtains activity information representing an activity of a person involved in the activity;

event information obtaining means that obtains event information including information representing an event to which the activity-involved person participates, and information on a time at which the event occurs;

evaluation obtaining means that obtains, for the activity of the activity-involved person, at least one of a subjective evaluation from the activity-involved person and a subjective evaluation from an evaluating person who evaluates the activity-involved person;

short-term context calculating means that generates, from the activity information obtained by the activity information obtaining means, a short-term context which is a vector including values of the activity information of a predetermined kind during a predetermined time period arranged as elements of the vector in a predetermined order;

long-term context calculating means that extracts a long-term context which is a vector including values of the event information of a predetermined kind during a predetermined time period arranged as elements of the vector in a predetermined order;

model generating means that generates, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and

intellectual productivity estimating means that calculates, using the estimation model generated by the model generating means, an intellectual productivity that is a mapping to the space of the subjective evaluation from the short-term context of the activity of the activity-involved person and the long-term context thereof.

(Supplementary note 2)

The intellectual productivity measurement device according to Supplementary note 1, further including:

work-segment obtaining means that obtains a work segment which includes a work detail input for a predetermined work included in the activity of the activity-involved person, a work start time and a work end time; and

means that generates a feature vector obtained by arranging, in time series, the work segments in a predetermined time period, in which

the model generating means generates, using a predetermined mapping function from a direct sum space of a space of the short-term context, a space of the long-term context, and a space of the feature vector of the work segment to a space of the subjective evaluation, the estimation model for an intellectual productivity which is a parameter of the mapping function in such a way that values reflecting the short-term context of the activity-involved person, the long-term context thereof and the feature vector enter within a predetermined range of the subjective evaluation to the activity-involved person, and

the intellectual productivity estimating means calculates the intellectual productivity of the activity from the short-term context, the long-term context, and the feature vector.

(Supplementary note 3)

The intellectual productivity measurement device according to Supplementary note 1 or 2, in which the activity information obtaining means collects, as the activity information of the activity-involved person, at least one of followings: positional information of the activity-involved person; visual line information of the activity-involved person; environmental sound information around the activity of the activity-involved person; uttered sound information of the activity-involved person; operation information given by the activity-involved person to a computer input device; operation information given by the activity-involved person to a software; or operation information given by the activity-involved person to an office equipment.

(Supplementary note 4)

The intellectual productivity measurement device according to any one of Supplementary note 1 to 3, in which the event information obtaining means obtains the event information including a number of occurrences of the event of a kind, a frequency or an occurrence cycle of the event, or a percentage of a time at which the event is occurring during a predetermined time period.

(Supplementary note 5)

The intellectual productivity measurement device according to any one of Supplementary note 1 to 4, in which the event information obtaining means obtains the event information from at least one of a schedule table, a timetable, an activity achievement table, a process managing table, or an activity report including information on the event to which the activity-involved person participates.

(Supplementary note 6)

An intellectual productivity measurement method executed by an intellectual productivity measurement device that estimates an intellectual productivity of an activity of a person involved in the activity, the method including:

an activity information obtaining step for obtaining activity information representing an activity of a person involved in the activity;

an event information obtaining step for obtaining event information including information representing an event to which the activity-involved person participates, and information on a time at which the event occurs;

an evaluation obtaining step for obtaining, for the activity of the activity-involved person, at least one of a subjective evaluation from the activity-involved person and a subjective evaluation from an evaluating person who evaluates the activity-involved person;

a short-term context calculating step for generating, from the activity information obtained through the activity information obtaining step, a short-term context which is a vector including values of the activity information of a predetermined kind during a predetermined time period arranged as elements of the vector in a predetermined order;

a long-term context calculating step for extracting a long-term context which is a vector including values of the event information of a predetermined kind during a predetermined time period arranged as elements of the vector in a predetermined order;

a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and

an intellectual productivity estimating step for calculating, using the estimation model generated through the model generating step, an intellectual productivity that is a mapping to the space of the subjective evaluation from the short-term context of the activity of the activity-involved person and the long-term context thereof.

(Supplementary note 7)

The intellectual productivity measurement method according to Supplementary note 6, further including:

a work-segment obtaining step for obtaining a work segment which includes a work detail input for a predetermined work included in the activity of the activity-involved person, a work start time and a work end time; and

a step for generating a feature vector obtained by arranging, in time series, the work segments in a predetermined time period, in which

the model generating step generates, using a predetermined mapping function from a direct sum space of a space of the short-term context, a space of the long-term context, and a space of the feature vector of the work segment to a space of the subjective evaluation, the estimation model for an intellectual productivity which is a parameter of the mapping function in such a way that values reflecting the short-term context of the activity-involved person, the long-term context thereof and the feature vector enter within a predetermined range of the subjective evaluation to the activity-involved person, and

the intellectual productivity estimating step calculates the intellectual productivity of the activity from the short-term context, the long-term context, and the feature vector.

(Supplementary note 8)

The intellectual productivity measurement method according to Supplementary note 6 or 7, in which the activity information obtaining step collects, as the activity information of the activity-involved person, at least one of followings: positional information of the activity-involved person; visual line information of the activity-involved person; environmental sound information around the activity of the activity-involved person; uttered sound information of the activity-involved person: operation information given by the activity-involved person to a computer input device; operation information given by the activity-involved person to a software; or operation information given by the activity-involved person to an office equipment.

(Supplementary note 9)

The intellectual productivity measurement method according to any one of Supplementary note 6 to 8, in which the event information obtaining step obtains the event information including a number of occurrences of the event of a kind, a frequency or an occurrence cycle of the event, or a percentage of a time at which the event is occurring during a predetermined time period.

(Supplementary note 10)

The intellectual productivity measurement method according to any one of Supplementary note 6 to 9, in which the event information obtaining step obtains the event information from at least one of a schedule table, a timetable, an activity achievement table, a process managing table, or an activity report including information on the event to which the activity-involved person participates.

(Supplementary note 11)

A computer-readable recording medium having stored therein an intellectual productivity measuring program that allows a computer to execute:

an activity information obtaining step for obtaining activity information representing an activity of a person involved in the activity;

an event information obtaining step for obtaining event information including information representing an event to which the activity-involved person participates, and information on a time at which the event occurs;

an evaluation obtaining step for obtaining, for the activity of the activity-involved person, at least one of a subjective evaluation from the activity-involved person and a subjective evaluation from an evaluating person who evaluates the activity-involved person;

a short-term context calculating step for generating, from the activity information obtained through the activity information obtaining step, a short-term context which is a vector including values of the activity information of a predetermined kind during a predetermined time period arranged as elements of the vector in a predetermined order;

a long-term context calculating step for extracting a long-term context which is a vector including values of the event information of a predetermined kind during a predetermined time period arranged as elements of the vector in a predetermined order;

a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and

an intellectual productivity estimating step for calculating, using the estimation model generated through the model generating step, an intellectual productivity that is a mapping to the space of the subjective evaluation from the short-term context of the activity of the activity-involved person and the long-term context thereof.

This application is based on Japanese Patent Application No. 2010-139713 filed on Jun. 18, 2010, the entire specification, claims and drawings of which are herein incorporated in this specification by reference.

### INDUSTRIAL APPLICABILITY

The present invention is available to a human resource evaluation, a work analysis, and an improvement of an efficiency in a company.

### DESCRIPTION OF REFERENCE NUMERALS

1 Input device
2 Calculator
3 Memory
4 Evaluation obtainer
5 Model generator
6 Intellectual productivity calculator
6a Estimator
7a Work-segment input section
7b Vector generator
8 Output device
9 Terminal
10a Activity information obtainer
10b Event information obtainer
11a Short-term-context input section
11b Long-term-context input section
21a Short-term-context calculating section
21b Long-term-context calculating section
51 RF tag
52 Positional information transmitter
53 Tag information transmitter/receiver
54 Position calculator
60 Internal bus
61 Controller
62 Main memory
63 External memory
64 Operating device
65 Display
66 Transmitter/receiver
69 Control program
100 Intellectual productivity measurement device
N Network

1. An intellectual productivity measurement device comprising:
an activity information obtainer that obtains activity information representing an activity of a person involved in the activity;
an event information obtainer that obtains event information including information representing an event to which the activity-involved person participates, and information on a time at which the event occurs;
an evaluation obtainer that obtains, for the activity of the activity-involved person, at least one of a subjective evaluation from the activity-involved person and a subjective evaluation from an evaluating person who evaluates the activity-involved person;
a short-term context calculating section that generates, from the activity information obtained by the activity information obtainer, a short-term context which is a vector including values of the activity information of a predetermined kind during a predetermined time period arranged as elements of the vector in a predetermined order;
a long-term context calculating section that extracts a long-term context which is a vector including values of the event information of a predetermined kind during a predetermined time period arranged as elements of the vector in a predetermined order;
a model generator that generates, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and
an intellectual productivity estimator that calculates, using the estimation model generated by the model generator, an intellectual productivity that is a mapping to the space of the subjective evaluation from the short-term context of the activity of the activity-involved person and the long-term context thereof.

2. The intellectual productivity measurement device according to claim 1, further comprising:
a work-segment obtainer that obtains a work segment which includes a work detail input for a predetermined work included in the activity of the activity-involved person, a work start time and a work end time; and
a vector generator that generates a feature vector obtained by arranging, in time series, the work segments in a predetermined time period, wherein
the model generator generates, using a predetermined mapping function from a direct sum space of a space of the short-term context, a space of the long-term context, and a space of the feature vector of the work segment to a space of the subjective evaluation, the estimation model for an intellectual productivity which is a parameter of the mapping function in such a way that values reflecting the short-term context of the activity-involved person, the long-term context thereof and the feature vector enter within a predetermined range of the subjective evaluation to the activity-involved person, and
the intellectual productivity estimator calculates the intellectual productivity of the activity from the short-term context, the long-term context, and the feature vector.

3. The intellectual productivity measurement device according to claim 1, wherein the activity information obtainer collects, as the activity information of the activity-involved person, at least one of followings: positional information of the activity-involved person; visual line information of the activity-involved person; environmental sound information around the activity of the activity-involved person; uttered sound information of the activity-involved person; operation information given by the activity-involved person to a computer input device; operation information given by the activity-involved person to a software; or operation information given by the activity-involved person to an office equipment.

4. The intellectual productivity measurement device according to claim 1, wherein the event information obtainer obtains the event information including a number of occurrences of the event of a kind, a frequency or an occurrence cycle of the event, or a percentage of a time at which the event is occurring during a predetermined time period.

5. The intellectual productivity measurement device according to claim 1, wherein the event information obtainer obtains the event information from at least one of a schedule table, a timetable, an activity achievement table, a process managing table, or an activity report including information on the event to which the activity-involved person participates.

6. An intellectual productivity measurement method executed by an intellectual productivity measurement device that estimates an intellectual productivity of an activity of a person involved in the activity, the method comprising:
an activity information obtaining step for obtaining activity information representing an activity of a person involved in the activity;
an event information obtaining step for obtaining event information including information representing an event to which the activity-involved person participates, and information on a time at which the event occurs;
an evaluation obtaining step for obtaining, for the activity of the activity-involved person, at least one of a subjective evaluation from the activity-involved person and a subjective evaluation from an evaluating person who evaluates the activity-involved person;
a short-term context calculating step for generating, from the activity information obtained through the activity information obtaining step, a short-term context which is a vector including values of the activity information of a predetermined kind during a predetermined time period arranged as elements of the vector in a predetermined order;
a long-term context calculating step for extracting a long-term context which is a vector including values of the event information of a predetermined kind during a predetermined time period arranged as elements of the vector in a predetermined order;
a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and
an intellectual productivity estimating step for calculating, using the estimation model generated through the model generating step, an intellectual productivity that is a mapping to the space of the subjective evaluation from the short-term context of the activity of the activity-involved person and the long-term context thereof.

7. The intellectual productivity measurement method according to claim 6, further comprising:
a work-segment obtaining step for obtaining a work segment which includes a work detail input for a predetermined work included in the activity of the activity-involved person, a work start time and a work end time; and
a step for generating a feature vector obtained by arranging, in time series, the work segments in a predetermined time period, wherein
the model generating step generates, using a predetermined mapping function from a direct sum space of a space of the short-term context, a space of the long-term context, and a space of the feature vector of the work segment to a space of the subjective evaluation, the estimation model for an intellectual productivity which is a parameter of the mapping function in such a way that values reflecting the short-term context of the activity-involved person, the long-term context thereof and the feature vector enter within a predetermined range of the subjective evaluation to the activity-involved person, and
the intellectual productivity estimating step calculates the intellectual productivity of the activity from the short-term context, the long-term context, and the feature vector.

8. The intellectual productivity measurement method according to claim 6, wherein the activity information obtaining step collects, as the activity information of the activity-involved person, at least one of followings: positional information of the activity-involved person; visual line information of the activity-involved person; environmental sound information around the activity of the activity-involved person; uttered sound information of the activity-involved person: operation information given by the activity-involved person to a computer input device; operation information given by the activity-involved person to a software; or operation information given by the activity-involved person to an office equipment.

9. The intellectual productivity measurement method according to claim 6, wherein the event information obtaining step obtains the event information including a number of occurrences of the event of a kind, a frequency or an occurrence cycle of the event, or a percentage of a time at which the event is occurring during a predetermined time period.

10. A computer-readable recording medium having stored therein an intellectual productivity measuring program that allows a computer to execute:
an activity information obtaining step for obtaining activity information representing an activity of a person involved in the activity;
an event information obtaining step for obtaining event information including information representing an event to which the activity-involved person participates, and information on a time at which the event occurs;
an evaluation obtaining step for obtaining, for the activity of the activity-involved person, at least one of a subjective evaluation from the activity-involved person and a subjective evaluation from an evaluating person who evaluates the activity-involved person;
a short-term context calculating step for generating, from the activity information obtained through the activity information obtaining step, a short-term context which is a vector including values of the activity information of a predetermined kind during a predetermined time period arranged as elements of the vector in a predetermined order;
a long-term context calculating step for extracting a long-term context which is a vector including values of the event information of a predetermined kind during a predetermined time period arranged as elements of the vector in a predetermined order;
a model generating step for generating, using a predetermined mapping function from a direct sum space of a space of the short-term context and a space of the long-term context to a space of the subjective evaluation, an estimation model which is a parameter of the mapping function in such a way that values reflecting the short-term context of the activity-involved person and the long-term context thereof enter within a predetermined range of the subjective evaluation to the activity-involved person; and
an intellectual productivity estimating step for calculating, using the estimation model generated through the model generating step, an intellectual productivity that is a mapping to the space of the subjective evaluation from the short-term context of the activity of the activity-involved person and the long-term context thereof.
